(19) United States
(12) Patent Application Publication
(10) Pub. No.: US 2015/0254719 A1
(43) Pub. Date: Sep. 10, 2015

(54) Prediction of Vehicle Transactions and Targeted Advertising Using Vehicle Telematics

(71) Applicant: HTI, IP, L.L.C., Arlington, VA (US)

(72) Inventors: James R. Barfield, JR., Atlanta, GA (US); Stephen Welch, Atlanta, GA (US); Thomas Steven Taylor, Atlanta, GA (US)

(73) Assignee: HTI, IP, L.L.C., Arlington, VA (US)

(21) Appl. No.: 14/197,286

(22) Filed: Mar. 5, 2014

(51) Int. Cl. G06Q 30/02; G07C 5/00

(52) U.S. Cl. CPC G06Q 30/0265; G07C 5/008; G06Q 30/0255; G06Q 30/0261; G06Q 30/0273

(57) ABSTRACT

A method of generating targeted advertisements includes receiving vehicle information, such as vehicle diagnostics information, from on-board devices installed in vehicles. A processor may then predict, based on the vehicle information, that a given vehicle user will engage in a financial transaction involving their vehicle, such as a purchase of a replacement vehicle or repair, within a predetermined amount of time. This prediction may be used to match a vendor to the given vehicle user, and a targeted advertisement from the matched vendor, the subject matter of which correspond to the predicted financial transaction, may be delivered to the given user.

### BACKGROUND

“Telematics” refers generally to the integration of telecommunications and informatics (i.e., the use of telecommunications and computer technologies to access, store, transmit, and manipulate information). A particular type of telematics is vehicle telematics, which relates, in one sense, to the communication of data between a vehicle and some external computing device via telecommunications technologies. Examples of vehicle telematics include automobile GPS navigation systems, fleet tracking and management systems, vehicle usage monitoring systems (e.g., for automobile insurance discount programs), and wireless safety and warnings systems.

Telematics devices facilitate connecting a vehicle with a communications network. A telematics control unit (“TCU”) is a telematics device that may be installed in a vehicle, and generally includes wireless communication circuitry having long-range wireless capability (e.g., cellular telephony and data services) and perhaps also short-range wireless capability (e.g., “Bluetooth”). A TCU typically includes at least one processor that controls, operates, and manages the circuitry and software running thereon, and may also facilitate interfacing with a vehicle data bus of the vehicle in which the TCU is installed. A TCU may also include various other functional units, such as a location unit (e.g., a global positioning satellite (“GPS”) circuit).

For example, a TCU may be installed by a vehicle's original equipment manufacturer (“OEM”) such as Ford, Toyota, BMW, Mercedes Benz, etc. Such OEM-installed TCU's typically couple directly to the corresponding vehicle's data bus, such as, for example, a controller area network (“CAN”) bus, an international standards organization (“ISO”) bus, a Society of Automotive Engineers (“SAE”) bus, etc. The OEM-installed TCU can process and communicate information about the vehicle retrieved from the bus via links of the wireless communication networks, to a user's mobile device local to the vehicle, or to a computer device remote from the vehicle. Aftermarket vendors also produce TCUs, generally in the form of a module that plugs into a diagnostic connection port of a vehicle, such as, for example, and On-Board Diagnostics (“OBD”) port, or OBD-II port. Such a self-contained, aftermarket, plug-in device is often referred to in the art as a ‘dongle’ or an OBD device.

A TCU generally communicates vehicle information to a central host telematics server, which provides gatekeeper functionality in forwarding messages to and receiving messages from, a TCU coupled to a vehicle bus.

### BRIEF DESCRIPTION OF THE DRAWINGS

FIG. 1 illustrates an exemplary system for obtaining vehicle telematics data.

FIG. 2 is a block diagram illustrating an exemplary On-Board Diagnostics (“OBD”) device.

FIG. 3 illustrates an exemplary process for predicting transaction related to OBD device users' vehicles.

FIG. 4 illustrates conceptually an exemplary operation of a prediction heuristic operating to predict the replacement of a vehicle.

FIG. 5 illustrates conceptually an exemplary operation of a prediction heuristic operating to predict a type of a replacement vehicle.

FIG. 6 illustrates conceptually an exemplary operation of a prediction heuristic operating to predict the repair of a vehicle.

FIG. 7 illustrates conceptually an exemplary operation of a prediction heuristic operating to predict a type of repair of a vehicle.

FIG. 8 illustrates conceptually an exemplary Artificial Neural Network (“ANN”).

FIG. 9 illustrates an exemplary process for generating a targeted advertisement.

FIG. 10 illustrates an exemplary process for selecting a vendor for a targeted advertisement.

FIG. 11 illustrates conceptually an exemplary operation of an advertisement generation module operating to generate a targeted advertisement for replacement of a vehicle.

FIG. 12 illustrates conceptually an exemplary operation of an advertisement generation module operating to generate a targeted advertisement for repair of a vehicle.

FIG. 13 illustrates an exemplary vendor advertisement bid interface.

### DETAILED DESCRIPTION

Telematics data from vehicles that have an OBD device installed therein may be used to generate targeted advertisements for owners of the vehicles that are particularly well tailored to the individual situations of the vehicle owners. For example, the telematics data may be used to predict whether a particular vehicle owner will engage in a vehicle-related transaction (e.g., buy a new car, repair their car, etc.) in the near future, to predict a time frame in which the vehicle-related transaction is likely to occur, and to predict certain details of the vehicle-related transaction (e.g., what type of new car/repair). Additional information (e.g., demographics data), which may be derived from the vehicle information or gathered through other sources, may be combined with the telematics data in the predictions to increase the accuracy thereof. An advertisement that is specifically related to the predicted transaction (e.g., an advertisement for a new car) may be delivered to the vehicle owner. The advertisement may be specifically tailored to various details of the transaction that have been predicted based on the telematics data (e.g., a specific car for sale near the particular user is advertised).

Such targeted advertisements, generated based on telematics data, are more likely to be relevant to the current situations of the vehicle owners than general advertisements; thus, they are more likely to command a higher price for the company generating the advertisements. Moreover, an advertising interface can provide vendors wishing to advertise a greater opportunity to customize their purchasing of advertisements so as to maximize their effectiveness. For example, vendors wishing to advertise may variably set certain thresholds for predicted probabilities or predicted time frames of vehicle-related transactions, and their advertisements will only be delivered to users whose predicted probability/time frame meet the thresholds. Thus, the vendors can ensure that their advertisements are directed to those customers most likely to be interested in the advertisement and that the advertisements are delivered at a timing when the advertisement will be most efficacious.

[Aggregation of Data]

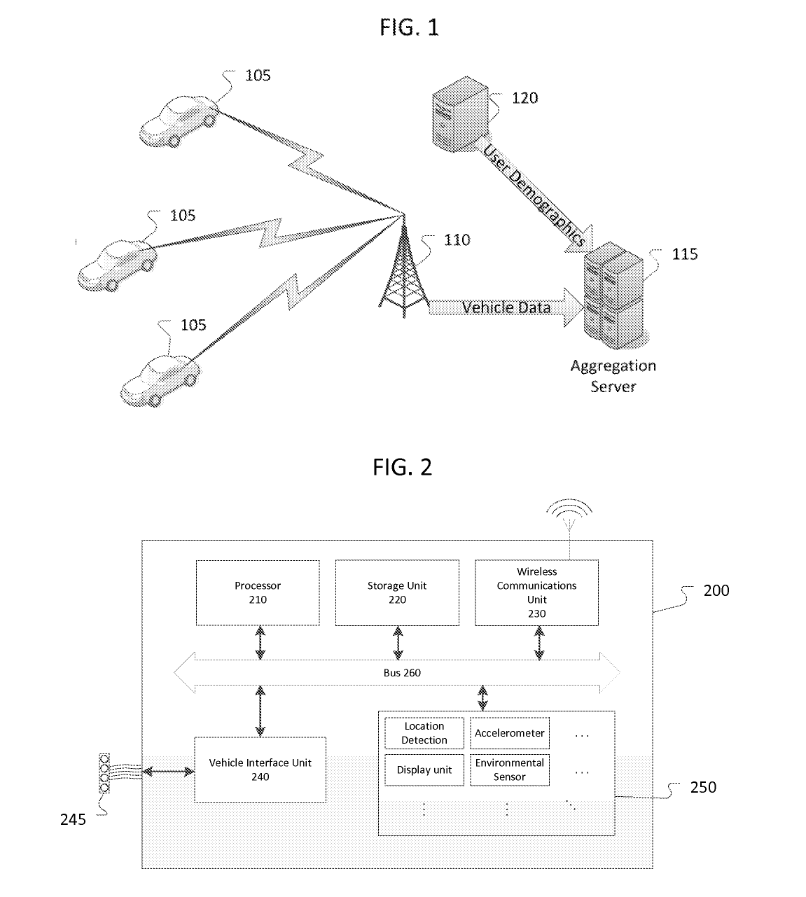

FIG. 1 is a conceptual diagram illustrating aggregation of data used in generating the advertisements and/or predictions. Multiple vehicles 105 are illustrated that each have an OBD device 200 installed therein. The OBD device 200 of each vehicle 105 wirelessly communicates with a network 110, which may be, for example, a cellular communications network. In one exemplary approach the network 110 is a packet-switched network, such as a 4G-LTE network. The OBD devices 200 communicate to the network 110 data that is related to the particular vehicle 105 in which the OBD device 200 is installed and that is obtained by the OBD device 200 in the vehicle. This data may be called herein “vehicle data” for simplicity.

The network 110 is connected with an aggregation server 115. The aggregation server 115 may be, for example, a server of a Telematics Service Provider that is associated with the OBD devices 200. For example, the users of the vehicles 105 may have service contracts with the Telematics Service Provider for various telematics services. Further, the Telematics Service Provider may be the entity from which the OBD devices 200 were purchased/rented/loaned, although this need not necessarily be the case. The Telematics Service Provider may be, but need not necessarily be, the same entity as or affiliated with the operator of the network 110.

In addition to the vehicle data received from the OBD devices 200, the aggregation server may also receive additional data from non-OBD device sources. For example, FIG. 1 illustrates the aggregation server receiving user demographics data from a server 120. The server 120 may be, for example, operated by a third party, such as a social media service provider (e.g., Facebook), from whom the Telematics Service Provider may purchase the information. In an exemplary approach, a social media service provider provides user demographics data and at least some of the targeted advertisements (discussed further below) are delivered to the vehicle users via the social media service provider's social media service. As an alternative or supplement to obtaining user demographics from a third-party, the Telematics Service Provider may also generate such data in-house. For example, at least some types of user demographics information may be derived by the Telematics Service Provider from the vehicle data itself, from information submitted to the Telematics Service Provider by the users, from publically available information (e.g., census info), and so on.

For simplicity, in the description that follows, various processes will be described as being performed by the aggregation server 115. However, it will be understood that the aggregation server 115 is not necessarily a single computing device, and may include one or more discrete computing devices (each including one or more processors). Thus, it will be understood that, as used herein and in the appended claims, when it is said that “the aggregation server” or “a computing device” or “a processor” performs certain functions, one or more processors included in one or more computing devices may separately or collectively perform the function, unless specifically indicated otherwise. The aggregation server 115 stores the vehicle data and other data (e.g., user demographics). The aggregation server 115 may also be configured to perform the predictions and advertisement generation that will be described further below.

[OBD Device]

FIG. 2 is a block diagram illustrating an exemplary OBD device 200. The OBD device 200 may include a processor 210, a storage unit 220, a wireless communications unit 230, a vehicle interface unit 240, and special functions units 250. The components of the OBD device 200 may be communicably connected to each other, for example via the bus 260.

The processor 210 may control the operations of the other components of the OBD device 200 and execute various programs stored thereon. The processor 210 may receive vehicle information from a diagnostic connection such as an OBD-II port (discussed further below) and processes, derives, and transforms the information before transmitting it to a remote server (such as the aggregation server 115 or others), or to a user device local to the vehicle such as a smart phone. The processor 210 can also receive signals from a remote server (such as the aggregation server 115 or others) or smart phone local to the vehicle, via a long range or short range wireless connection, or via a wired connection, process the received signal, and transfer the processed signal, via the diagnostic connection to the vehicle bus.

The storage unit 220 may store program code for execution by the processor 210 and data obtained or generated by the OBD device 200.

The wireless communications unit 230 may include any circuitry for communicating with a remote network, such as a wireless transceiver similar to those used in a cellular telephone. The wireless communications unit 230 may also include a long range wireless communication processor (not illustrated) and related circuitry, such as, for example, a processor for performing voice compression and decompression heuristics, radio transceiver circuitry for transmitting and receiving data and voice signals over a long range wireless communication network. This dedicated communications processor may be provided in addition to the processor 210, or instead the processor 210 may be configured to perform these functions. In addition, the wireless communications unit 230 can include a short-range wireless transceiver, such as Bluetooth®, Wi-Fi, Near Field Communication (“NFC”) or similar.

The vehicle interface unit 240 is configured to interface with a bus of the vehicle and to obtain information therefrom, such as OBD information. The vehicle interface unit 240 may connect to a vehicle data and information bus, such as a CAN-bus, or similar diagnostics bus, via a connector 245, such as an OBD port, OBD-II port, or similar connector.

The OBD device 200 may also include various units configured to perform certain special functions. Examples of such units are illustrated in FIG. 2 in the special functions units 250 block. These units can include a location detection unit (e.g., global positioning satellite circuitry, firmware, and software), accelerometers, environmental sensors (e.g., barometric pressure sensors, thermometers), microphones, speakers, buttons, displays, etc.

Although FIG. 2 illustrates the components of the OBD device 200 as being contained in a single unit, this need not be the case. The above-described components of an OBD device 200 may be distributed among multiple devices, such as in a dongle unit and one of more devices remote from the dongle (e.g., a rear-view mirror unit).

The vehicle data transmitted by the OBD device 200 may include data obtained from the vehicle data and information bus to which it is connected. For example, the vehicle data may include, the Vehicle Identification Number (“VIN”) of the vehicle (from which the make/model/year of the vehicle can be obtained), diagnostics information (e.g., diagnostic trouble codes, system status codes, etc.), engine load information, RPMs, air intake information, the odometer reading, the speed of the vehicle, stops/starts of the vehicle, and the like. The condition of the vehicle and the make/model/year of the vehicle can be derived from the aforementioned vehicle data. Such a derivation could be made locally by the OBD device 200, in which case the condition and/or make/model/year of the vehicle could be transmitted by the OBD device 200 as vehicle data, or the derivation could be made by the aggregation server 115. Such data that can be derived from other vehicle data transmitted by the OBD devices 200 may be treated herein for simplicity as “vehicle data,” regardless of whether or not it was transmitted by the OBD devices 200 or derived from transmitted data. Moreover, the vehicle data may include data obtained from any special functions units 250 included in the OBD device or other sensors/devices in or near the vehicle that communicate with the OBD device 200. For example, the vehicle data may include location information (GPS, GLONASS), acceleration information, environmental information (temperature, barometric pressure, etc.), and so on.

[Prediction of Vehicle-Related Transaction—Overview]

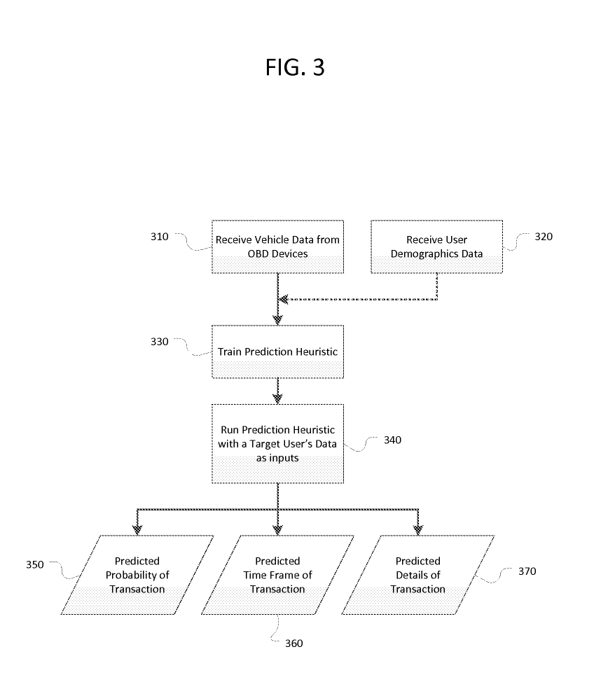

FIG. 3 illustrates an exemplary process whereby predictions about a vehicle-related transaction may be made. This process may be performed, for example, by the aggregation server 115 running a prediction heuristic 400. For simplicity, the description herein will often refer to functions performed by “a prediction heuristic 400”, but it will be understood that multiple different heuristics may be used to perform the functions described as being performed by the prediction heuristic 400—for example, one heuristic predicting a probability of a transaction, one heuristic for predicting a timeframe of a transaction, one heuristic for predicting details of the transaction, and so on.

In process block 310 vehicle data is received from OBD devices 200 installed in multiple vehicles 105. The process then proceeds to block 330.

In process block 320 user demographics data may be received, for example from server 120. As discussed further below, the user demographics data may be used to further increase the accuracy of the predictions. Although not illustrated, all or part of the user demographics data may be derived from the vehicle data by the aggregation server 115 rather than being received as a separate data source. Additionally, in certain configurations the process block 320 may be omitted and the predictions based solely on the vehicle data.

In process block 330 a prediction heuristic 400 is “trained.” As discussed further below, the prediction heuristic 400 may comprise computational models such as neural networks, classification or regression trees, support vector machines, logistic regressors, guassian process models, or other computational models. “Training” as used herein simply means determining the appropriate coefficients, weights, groupings, connections, parameters, hyperparameters or other model attributes that are used by the overall heuristic to make predictions, by feeding as inputs into the heuristic “training data”, which includes at least some instances of the vehicle data (and the corresponding demographics data if used by the heuristic). Many computational or machine learning models are supervised, meaning that they are trained on labeled training examples having a known output for each example. Other computational or machine learning models may use “unsupervised learning”, which means that they are trained by unlabeled training examples that do not have known outputs for each example, the objective often being to discover underlying structure in the data itself (e.g. clustering).

For example, as discussed in greater detail below, if the prediction heuristic 400 is an artificial neural network model (used here as a supervised training model), various weights that are used by the neural network have to be learned. The neural network may learn these weights using the input training data and comparing the output result to known actual results (i.e., whether/when respective users corresponding to the input training data have engaged in the vehicle-related transaction of interest). A cost function related to the difference between the known results and the output results is computed, and the optimal weights are those that minimize this cost function. The optimal weights may be determined by numerous method of minimizing the cost function while minimizing model complexity, including statistical methods such as stochastic gradient descent or batch gradient descent. Once trained, the neural network can operate on inputs that do not have known results using the weights learned in training, and thereby generate an output that may accurately predict whether (or when) a user will engage in a vehicle related transaction.

The accuracy of the predictions will depend upon the complexity of the prediction heuristic 400 (how many independent variables/neurons/neuron-layers/etc. are considered), the number of instances of training data used to train the prediction heuristic 400, and the training data itself. Moreover, since the data set utilized by the aggregation server 115 is not static and may continually receive new data or updates to previously received data, the prediction heuristic 400 may be configured to periodically re-train as new data/updated data is received. When new model parameters are learned, the reliability of the new model may be evaluated using cross validation techniques, wherein a portion of the data not previously used in training, is fed into the model, and the accuracy of the newly learned model on the cross-validation data is determined. New models may be rejected if they do not meet predetermined accuracy or error thresholds. Once training has been performed, the process passes to block 340.

In process block 340, the prediction heuristic 400 (already having been trained) is run using a target user's vehicle and/or demographics data as inputs. The prediction heuristic 400 may then output predictions concerning a financial transaction related to the user's vehicle, including any one of (or all of) the outputs 350, 360, and 370.

The output 350 is a prediction of the probability that the given user will engage in a specific financial transaction related to their vehicle (“vehicle-related transaction”). Vehicle-related transactions include, for example, replacing the vehicle and purchasing repairs for the vehicle. As used in this disclosure and in the appended claims “replacing” or “replacement of” a vehicle means any one of: a financial transaction in which both an old vehicle is sold and a new vehicle is purchased, a financial transaction in which the old vehicle is sold (but no new vehicle is purchased), or a financial transaction in which a new vehicle is purchased (but the old vehicle is retained). Moreover, as used herein and in the appended claims a “new vehicle” means a vehicle that is new “to the user,” which may include so-called “used” or “pre-owned” vehicles. In other words, a vehicle may be a “new vehicle” as long as it is not owned by the particular user making the purchase at the time the purchase is made, and does not necessarily have to be a “retail new” or “factory-new” vehicle unless specifically indicated otherwise. Further, as used herein and in the appended claims “repair” includes preventative maintenance (e.g., oil-change, tune-up, etc.) and vehicle upgrades (e.g., installing new sound system or tires), as well as repairs occurring in response to part damage, malfunction, or failure.

Because every vehicle user will almost certainly engage in a vehicle related transaction eventually, an absolute probability of such a transaction—a probability of the transaction >ever< occurring—may have little utility, since it will almost always be 100%. Thus, the output 350 may include, at least implicitly, a discrete timeframe. In other words, the prediction is a prediction, in one example, of the probability that the user will engage in the vehicle-related transaction within a certain timeframe. Details regarding prediction of probability will be discussed further below.

The output 360 is a prediction of a timeframe in which the given user will engage in the vehicle-related transaction. The prediction of the time frame may be related to the prediction of probability as already discussed, and may include an explicit or implicit probability determination. In other words, the predicted time frame may be derived from the probability of output 350 rather than itself being a direct output of the heuristic 400. For example, probabilities may be predicted for multiple timeframes, and the predicted timeframe of output 360 may be the earliest time period for which the predicted probability of a transaction exceeds a threshold probability. Alternatively, the timeframe may be itself the direct output of the heuristic 400, predicted independently of any probability predictions.

The output 370 is a prediction of certain details of the vehicle-related transaction. For example, a type of a replacement vehicle or a type of a repair may be predicted.

When the vehicle-related transaction is the replacement of the vehicle, the “type” of the replacement vehicle predicted by the output 370 may include a category of the vehicle, such as consumer vehicle, commercial truck, farm vehicle, construction vehicle, boat, aircraft, etc. The categories may also be more specific, such as car, truck, SUV, motorcycle, minivan, tractor, combine, bailer, dump truck, bulldozer, crane, etc. Categories of vehicles may also be subdivided into classes—for example, commonly recognized consumer vehicle classes include federal size classes (e.g., sub-compact, compact, mid-size, large), classes specified by the Association of Car Rental Industry Systems Standards (e.g., economy, standard, full-size, premium, luxury), and usage/body style classes used in the art and/or colloquially (e.g., sports car, station wagon, sedan, convertible, hatchback, crossover-SUV, hybrid-car, electric-car, light-truck, diesel truck, etc.). There is not necessarily a clear line between category and class, and thus as used herein and in the appended claims, “category” can mean any abstract classification based on the vehicles size/intended use/shape/quality unless specifically indicated otherwise. The “type” of vehicle predicted by the output 370 may also refer to any or all of the make, model, and/or year of the vehicle. The prediction of “a type” of the replacement vehicle does not necessarily have to be a prediction of only one type of replacement vehicle, but rather may include the prediction of a range of vehicle types most likely to be the subject of the predicted transaction. For example, supposing that the output 370 predicts the model of the replacement vehicle, the output 370 may specify the top five models that the user is likely to be interested in rather than only specifying the single most probable model.

When the vehicle-related transaction is the repair of the vehicle, the “type” of the repair predicted by the output 370 may refer to a category of repair, such as preventative maintenance, elective upgrades, body repair, or the repair of operational-systems of the vehicle. These categories may be broken down into more specific sub-categories, for example relating to the specific system affected (engine, transmission, general electrical, HVAC, fuel, emissions/exhaust, etc.). The “type” of the repair predicted by the output 360 may also refer to a specific part to be repaired. The prediction of “a type” of the repair does not necessarily have to be a prediction of only one type of repair, but rather may include the prediction of a range of repair types most likely to be the subject of the predicted transaction.

[Prediction Heuristic]

The prediction heuristic 400 can be any heuristic that can be trained using available data to predict future results. Computational or machine learning models may be used here as heuristics (or as a part thereof) and can generally be divided into two categories: regression and classification models. Regression models predict continuous values (e.g., predicting the probability of replacement), while classification models predict discrete values (e.g., predicting whether the user will replace or not).

As noted above, the prediction heuristic 400 can be a learning model. Learning models or machine learning generally describes classes of heuristics that learn from data rather than being explicitly programmed. Learning models include neural networks, classification or regression trees, support vector machines, logistic regressors, guassian process models, or other computational models.

A support vector machine is an example of a supervised learning model. They are useful for finding patterns in data and making classification or regression predictions. Support vector machines work by forming high dimensional boundaries (hyperplanes) between training examples, and using these boundaries to differentiate testing examples.

A classification tree or decision tree-learning model is a predictive model that maps inputs to outputs, specifically referred to as regression or classification trees. Decision trees are constructed by dividing training examples into subsets, one layer at a time, into more and more subclasses, ultimately resulting in a tree-like structure used for prediction. Decision trees may be pruned, or reduced in size/complexity by a number of methods to avoid overfitting.

A recommender system is an information filtering system that predicts the preference of a user, typically through collaborative or content-based filtering. Collaborative filtering includes filtering for information of patterns using methods involving multiple agents. For example, drivers with specific vehicles and demographics will be matched and expected to behave similarly to similar drivers historically. Collaborative filtering may make use of the computational models described herein, or other computational models.

Clustering is an unsupervised method of grouping similar data together, often in high dimensional space. Groups of data are called clusters and are centered around a centroid. Centroids may be understood as an archetype for a give cluster and can function as a type of pattern recognition. Each example can be characterized by its distance to the centroid, where shorted distances indicate more similarity.

An artificial neural network (“ANN”) is a machine learning technique that is inspired by biological neurons that modify the connection strength between neurons to adapt to particular training data. ANNs consist of interconnected nodes, or neurons, often with multiple layers. Like other learning techniques, ANNs can be used to uncover underlying structure to the data, and ANNs can be very effective at uncovering complex and non-linear behavior. Well-designed ANNs may generalize well (i.e., performs well on examples not seen in training; heuristics that do not generalize well are said to overfit the data).

Although any of the above learning models (or others not specifically mentioned) may be used to generate the predictions, the ANN will be discussed in greater detail below as an exemplary illustration of how a learning model could be employed to generate the predictions.

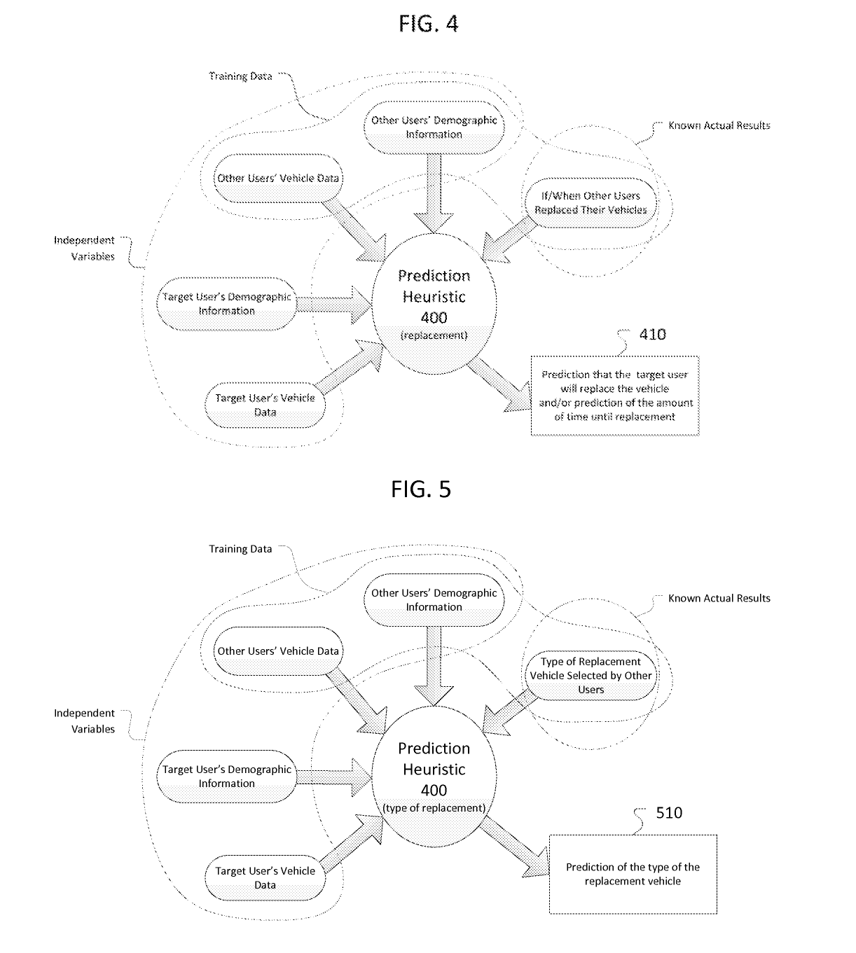

FIG. 4 illustrates a conceptual representation of the operation of the prediction heuristic 400 in the case in which the vehicle-related transaction is the replacement of the user's vehicle and the heuristic is a supervised learning heuristic. As shown in FIG. 4, the prediction heuristic 400 may take as inputs the data sets {target user's vehicle data}, {target user's demographic information}, {other user's vehicle data}, {other user's demographic information}, and {if/when other users replaced their vehicle}. The prediction heuristic 400 is first trained, as discussed above, with training data, which includes the data sets {other users' vehicle data} and {other users' demographic information} as independent variables and the data set {if/when other users replaced their vehicle} as the corresponding known result. After training, the prediction heuristic 400 is then run using the data sets {target user's vehicle data} and {target user's demographic information} as independent variable inputs, and the prediction heuristic 400 outputs predictions 410 about if and/or when the target user will replace their vehicle (and possibly also details about such replacement). These predictions 410 may then be used to generate a targeted advertisement for the target user, as discussed in greater detail below—for example, an advertisement related to the transaction of replacing the target user's vehicle (e.g., an ad for a new car).

The independent variables used by the heuristic 400 in the case in which the vehicle-related transaction is the replacement of the user's vehicle may include any variables that have some predictive value for replacement of a vehicle. Exemplary independent variables that may be most relevant to replacement of the user's vehicle include: vehicle data related to the condition of the vehicle, e.g., year of the vehicle (derived from the VIN), diagnostic trouble codes (current, if any, and historical) (number of such codes as well as type/severity), current odometer, and the history of engine load, RPMs, air intake, speed, acceleration, stops, and starts; vehicle data related to the current value of the vehicle, e.g., condition of vehicle (see above), make/model/year of the vehicle (derived from the VIN), and the current odometer; and the location of the vehicle. The aforementioned vehicle data may be particularly useful in predicting replacement, since it is assumed that a vehicle owner is more likely to replace their vehicle as the condition/value thereof declines and as the age/mileage thereof increases. Moreover, it is assumed that certain vehicles are held on to by owners longer than others for various reasons. In addition, it is assumed that certain people are more likely to replace their car than others would be to replace the same car. For example, wealthy persons may replace their cars more quickly, on average, than poorer persons. Thus, demographics data may be included as independent variables to make the prediction of replacement even more accurate. Exemplary independent variables based on the demographics information include age, gender, ethnicity, employment, education, and income. Some demographics data may be inferred from the vehicle data. For example, the vehicle data may include a location of the vehicle, and from this the income of the user may be inferred using, for example, an average income for the zip code of the vehicle. Other demographics data may be obtained from public records or from the Telematics Service Provider's own records, or may even be purchased from a third-party.

FIG. 5 illustrates a conceptual representation of the operation of the prediction heuristic 400 to predict a type of a replacement vehicle. The operations of the prediction heuristic 400 in the case of FIG. 5 may be similar to that described above with respect to FIG. 4, except that the data set {if/when other users replaced their vehicle} is changed to the data set {type of replacement vehicle selected by other users}, and the prediction 510 relates to the type of the replacement vehicle.

The independent variables used by the heuristic 400 to predict a type of a replacement vehicle may include, for example, vehicle information such as the make/model/year of the vehicle (derived from the VIN) and the location of the vehicle, and demographics information such as the user's age, gender, ethnicity, employment, education, income, home ownership, and marital status.

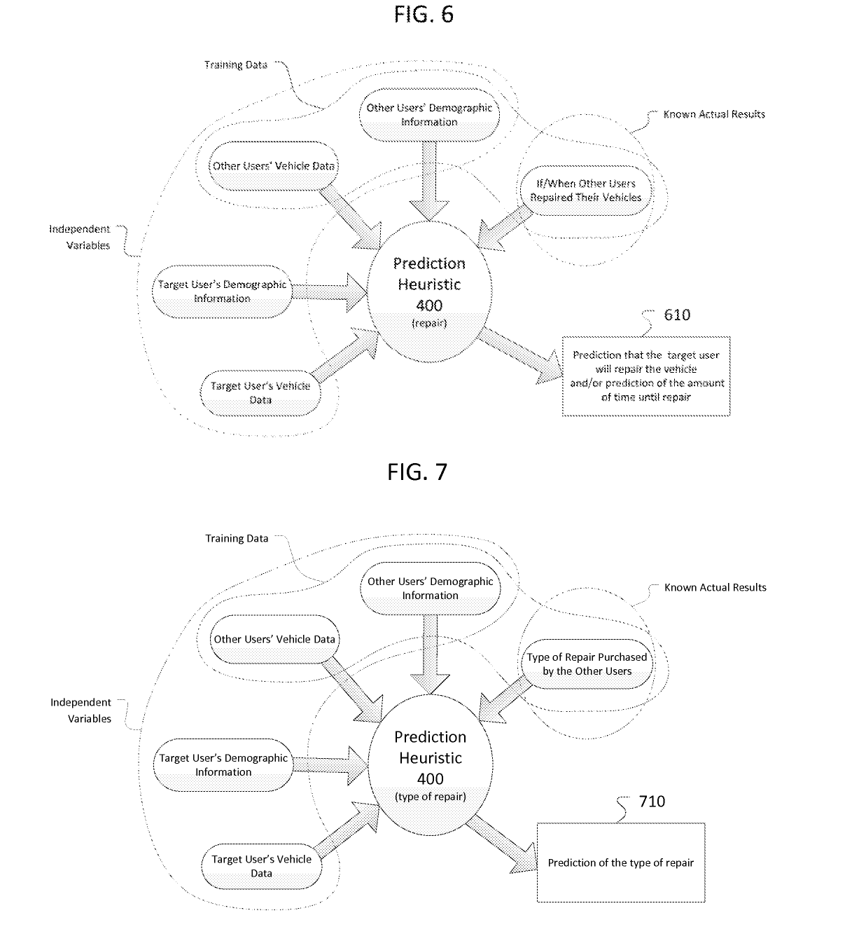

FIG. 6 illustrates a conceptual representation of the operation of the prediction heuristic 400 in the case in which the vehicle-related transaction is the repair of the user's vehicle. The operations of the prediction heuristic 400 in the case of FIG. 6 may be similar to that described above with respect to FIG. 4, except that the data set {if/when other users replaced their vehicle} is changed to the data set {if/when other users repaired their vehicle}, and the prediction 510 relates to repair of the target user's vehicle rather than replacement thereof.

The independent variables used by the heuristic 400 in the case in which the vehicle-related transaction is the repair of the user's vehicle may include similar variables as those used to predict replacement of the vehicle, although the various weights, coefficient, etc. of the heuristic 400 will likely differ from the case in which the vehicle-related transaction is the replacement of the user's vehicle, since some variable may be more predictive of repair than they are of replacement.

FIG. 7 illustrates a conceptual representation of the operation of the prediction heuristic 400 to predict a type of a repair. The operations of the prediction heuristic 400 in the case of FIG. 7 may be similar to that described above with respect to FIG. 5, except that the data set {type of replacement vehicle selected by other users} is changed to the data set {type of repair purchased by other users}.

The independent variables used by the heuristic 400 to predict a type of a repair include vehicle data such as the year of the vehicle (derived from the VIN), diagnostic trouble codes (especially current codes), current odometer, make/model/year of the vehicle (derived from the VIN), the location of the vehicle, and the history of engine load, RPMs, air intake, speed, acceleration, stops, and starts.

### Detailed Example

### Artificial Neural Network

A detailed description of an ANN is provided merely for illustrative purposes, and the disclosure is certainly not limited thereto. Suppose, that the ANN is designed to predict the number of months until a vehicle user will replace their vehicle. Suppose, for simplicity, that the ANN uses as independent variable inputs: user age, user gender, user income, vehicle make, vehicle model, and mileage of a vehicle. In order to train the ANN, training data is provided that includes points for each of the independent variables and also a known result—in this case, how long the user owned the vehicle before replacing the vehicle. Exemplary training data is included in the table below.

| | Variable | User 1 | User 2 | User 3 |
|---|---|---|---|---|
| Driver Age | x₁ | 43 | 41 | 24 |
| Gender | x₂ | Male | Male | Female |
| Income | x₃ | $40k | $32k | $43k |
| Make | x₄ | Toyota ™ | Toyota ™ | Tesla ™ |
| Model | x₅ | 4Runner ™ | Tacoma ™ | Model S ™ |
| Mileage | x₆ | 149,222 | 193,231 | 402 |
| Years owned | y | 9.7 | 11.3 | 2.1 |
| before | | | | |
| replacement | | | | |

As an initial step, discrete input data may be converted to numeric values, for example, −1 for male and 1 for female. Input data is then typically normalized, often by subtracting the mean and dividing by the standard deviation of all input values for a specific variable, as shown in equation (1) below, in which μ_{age} represents the mean of all ages, σ_{age} represented the standard deviation of all ages, Ageᵢ represents the age of user i, and Age_{norm,i} represents the normalized age of user i.

$${Age}_{norm , i} = \frac{{Age}_{i} - {μ}_{age}}{{σ}_{age}} \qquad ( 1 )$$

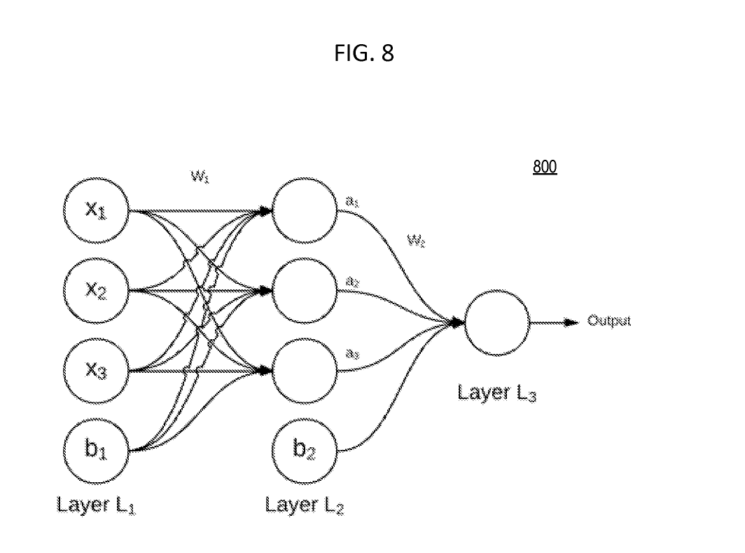

Normalized input values may then be stored in the vector Xₖ={x₁, x₂, x₃, x₄, x₅, x₆} and used as the inputs to a neural network, where k indicates the particular training example (in this case, the user). A simplified neural network is shown in FIG. 8 (note that only three inputs are shown in the figure for simplicity, rather than the seven described above). An ANN may include multiple “layers” of neurons. The neural network 800 in FIG. 8 includes of input layer L_1, hidden layer L_2, and output layer L_3. The structure of neural network 800 is shown as an informative example, where implementations may consist of more hidden layers, and more inputs. Each neuron in layers L_2 and L_3 sums all inputs thereto and applies the result of this summing as an input to its activation function. The result of the activation function is output from the neuron as an output. For example, a sigmoid function may be used as an activation function, resulting in an output from a given neuron as shown in equation (2).

$$neuron output = \frac{1}{1 + exp ( - {W}_{i}^{j} {X}^{T} + {b}_{i} )} \qquad ( 2 )$$

Where Wᵢ represents a matrix of weights (to be learned) applied to each input value, and bᵢ represents bias values (also may be learned). The index i indicates the layer of the neural network from which the inputs originated, and runs from 1 to n−1, where n is the total number of layers. The index j indicates the row of W corresponding to neuron j. Thus, the neural network 800 includes two weight matrices to be learned in the training process, W₁(3×3), and W₂(1×3), and two bias values b₁ and b₂, which may also be learned in the training process. Wᵢ^{j} corresponds to layer i and the row of W corresponding to neuron j. In this way inputs may be propagated forward through the network into a single output, or prediction.

A number of techniques exist for training the ANN, often relying on the back propagation of errors through the network. This technique relies on minimizing a cost function, and may rely on a number of techniques from the field of optimization. Equation (3) shows an exemplary “squared error” cost function for a single training example:

C(W,b;Xₖ,yₖ)=½∥outputₖ−yₖ∥² (3)

where C(W, b; Xₖ, yₖ) represents the cost of a specific set of weights for a single training example (Xₖ,yₖ). The cost for a given training example k may be understood as being proportional to the difference between the correct already-known output yₖ for the example k and the modeled output when Xₖ is input to the model.

In order to train the ANN, a total cost function representing the cost of all of the training examples is minimized. For example, a total cost function that includes the average cost for each of the training examples plus a regularization term (added to help avoid overfitting) may be used, as shown in equation (4):

$$C ( W , b ) = [ \frac{1}{m} {\sum }_{k = 1}^{m} ( \frac{1}{2} {‖ {output}_{k} - {y}_{k} ‖}^{2} ) ] + \frac{λ}{2} {\sum }_{i = 1}^{n - 1} {\sum }_{j = 1}^{N} {\sum }_{l = 1}^{M} {( {W}_{i}^{j , l} )}^{2} \qquad ( 4 )$$

where there are m training examples, and each weight matrix, Wᵢ, consist of N rows and M columns, and Wᵢ^{j,l} represents a single entry in matrix Wᵢ (recall that n is the number of neural network layers). The parameter λ may be tuned during the overall process and represents a trade-off between minimizing error and preventing overfitting. The total cost function may be minimized by any of a number of known optimization techniques, such as stochastic gradient descent or batch gradient descent.

The neural network 800 described above predicts when a user will replace their vehicle. In particular, after the neural network 800 is trained, when data Xₘ for a given user k=m is applied as an input, the network will output a number corresponding to the predicted number of years of ownership for the user k=m, which, together with knowledge about how long the user has owned the vehicle can be used to determine when the user will replace their vehicle.

The neural network 800 could be altered to predict other outcomes, such as a type of replacement vehicle and so on, by changing the known result y variable in training, and perhaps including more or different input variables. Moreover, the neural network 800 could be made more or less complex as needed. Merely as one example, the neural network 800 could be used to directly predict a probability of a user replacing a vehicle within a predetermined time period. For example, this might be accomplished by setting a predetermined time period (e.g., six months) and including as independent variables the timing of the occurrence of certain events (e.g., the occurrence of certain error codes, the reaching of certain odometer readings, etc.). In such an example, the known result yₖ could be a binary coded variable for whether the user k replaced their vehicle within the predetermined time period from the occurrence of any or all of the events. Upon proper training of the neural network 800, when data Xₘ for a given user k=m is applied as an input, the network will output a number between 0 and 1 corresponding to a predicted probability that the user k=m will replace their vehicle within the predetermine time period (e.g., the output 0.38 would mean a 38% probability of replacement). The predetermined time period used by the neural network 800a can be a fixed default value, or in one possible approach may be variably adjusted by a vendor seeking to purchase an advertisement. For example, the vendor may be able to specify that they only wish to advertise to users who have a 50% or greater probability of replacing their vehicle within the next 6 months.

[Target Advertising Based on the Predictions]

A targeted advertisement in a general sense is an advertisement directed toward a specific consumer based on information indicating that the specific consumer would be receptive to the particular advertisement. For example, a web-site may track the search queries entered by a particular consumer, deduce, based on those queries, that the particular consumer is likely to be interested in a certain product, and direct an advertisement for that certain product to the consumer. Targeted ads in general can be sold for a higher price than untargeted adds, on the theory that the targeted ad has a better chance of motivating a purchase since it is directed toward someone chosen specifically because of their receptivity to the ad. Of course, the effectiveness of a targeted ad—and thus the price that can be charged for the ad—depends upon the quality of the information upon which the targeting decision is made, as well as the quality of the heuristic that works upon that information.

The predictions discussed above about if and when a vehicle owner will engage in a vehicle related transaction are based on high-quality information, much of which is obtained directly from the vehicles themselves via the OBD devices 200. Moreover, the learning models discussed above may be used to generate high quality predictions based on this data. Accordingly, a targeted ad based on the above-described predictions would be of a very high quality, and a vendor (e.g., a dealer of vehicles or a repair service provider) may be willing to pay much more for such an advertisement than for general untargeted advertisements. Even targeted ads generated by other means would likely be quite inferior to a targeted ad generated based on the predictions based on the vehicle information obtained via the OBD devices 200. Some of the information most relevant to predicting a vehicle related transaction has heretofore been unavailable to advertisers, or available only through unreasonably difficult means.

The targeted advertisements based on the above-described predictions may be made by an advertisement generation module 1100. The advertisement generation module 1100 is merely one example of how the advertisements can be generated, of course, and the disclosure is not limited thereto. Moreover, the advertisement generation module 1100 may be included in the aggregation server 115, or may be included in a completely separate computing device. In a preferred embodiment, the Telematics Service Provider generates the predictions upon which the targeted advertisements are based. The Telematics Service Provider may also generate the targeted advertisements, or the targeted advertisements may be generated by some other entity that obtains the predictions from the Telematics Service Provider. Thus, as used herein and in the appended claims, “receiving” predictions can include either generating the predictions or obtaining the predictions from someone else who generated them.

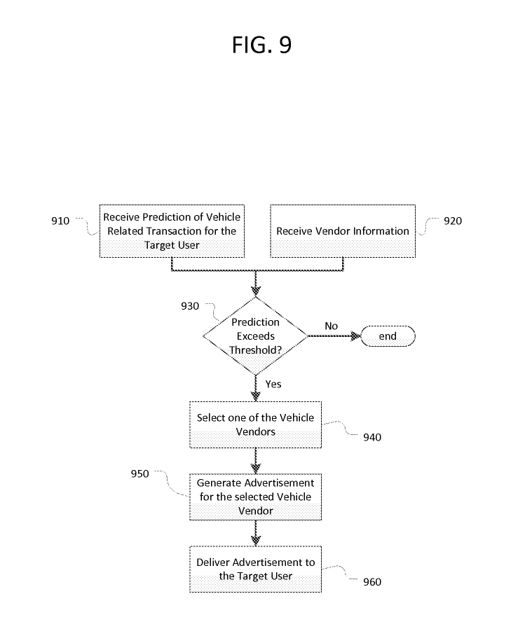

FIG. 9 illustrates an exemplary process whereby a targeted advertisement may be generated. In process block 910, predictions related to a vehicle related transaction for a target user are received. These predictions may include one or more of a prediction of a probability of the transaction (e.g., output 350), a prediction of a timeframe of the transaction (e.g., output 360), and a prediction of details of the transaction (e.g., output 370). In process block 920 vendor information is received. Vendors as used herein and in the appended claims include dealers of vehicles as well as those who provide repair-services and/or sell parts. A vendor's “inventory” may include vehicles for sale, as well as services offered, as the case may be. Thus, when “merchandise” in a vendor's inventory or an “item” of inventory are referred to, any one of a vehicle offered for purchase, a service offered for purchase, or a part offered for purchase may be referred to, unless specifically indicated otherwise. Vendor information can include general information about the types of vehicles or services offered by the vendor, specific information about items currently in the vendor's inventory, threshold information submitted by the vendor (discussed further below), and information about desired advertisements. The process then proceeds to decision block 930.

In decision block 930 it is determined whether the predictions for the target user meet/exceed certain threshold values. The threshold values may be predetermined values, or may be selected by the vendors and communicated to the advertisement module 1100 as part of the vendor information. For example, a prediction of a probability of a transaction occurring may be compared to probability threshold, a prediction of a timeframe of a transaction may be compared to a time threshold, and a prediction of a type of transaction may be compared to type criteria. If the predictions do not meet/exceed the thresholds for any vendors, then the process ends and no advertisement is generated for the target user. If the predictions do meet/exceed the thresholds for at least one vendor, then the process proceeds to block 940.

In process block 940, one of the vendors is selected. The vendor may be selected based on threshold information supplied by the vendor, as well as upon a bid provided by the vendor (discussed further below). The process proceeds to block 950.

In process block 950 an advertisement is generated for the selected vendor. Generation of the advertisement may include creating the advertisement from scratch, or simply readying for delivery a pre-made advertisement delivered by the selected vendor, or anything in between. The content of the advertisement may depend upon certain selections of the vendor as indicated by the vendor information. The process then proceeds to block 960.

In process block 960 the advertisement is delivered to the target user. For example, the advertisement could be delivered via a social feed, website, email, application etc. In one possible configuration, a social feed of the social networking service provider that provides certain demographic information to the aggregation server 115 is used to deliver the advertisement.

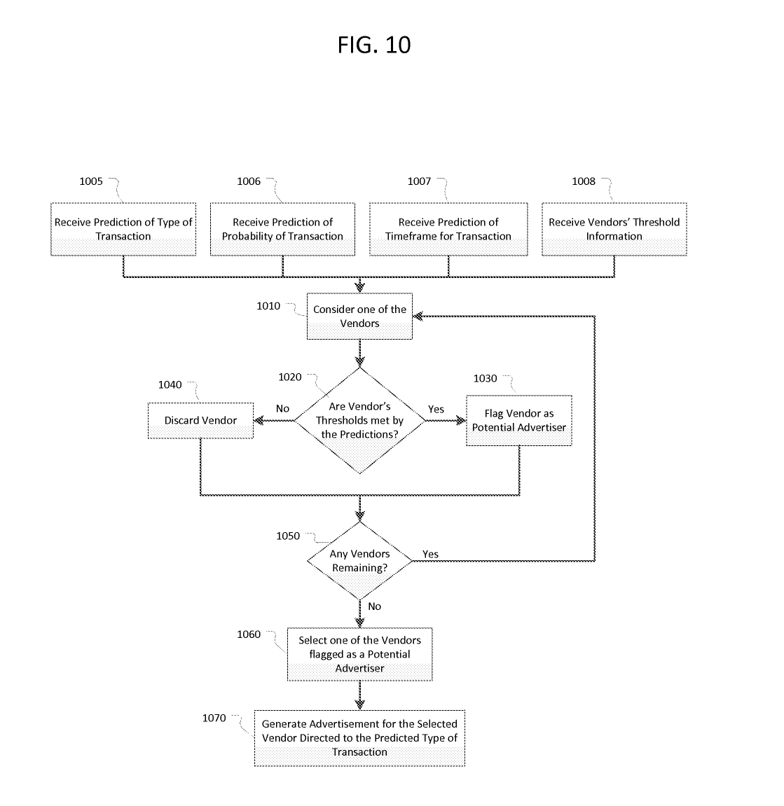

FIG. 10 illustrates in greater detail one possible example of the selection of a vendor as performed in block 940 of FIG. 9. In process blocks 1005, 1006, 1007, and 1008 information is received, including a prediction of a type of transaction, a prediction of a probability of a transaction, a prediction of the timeframe for the transaction, and threshold information from vendors.

In process block 1010 any one of the vendors is selected for consideration. The process then proceeds to decision block 1020.

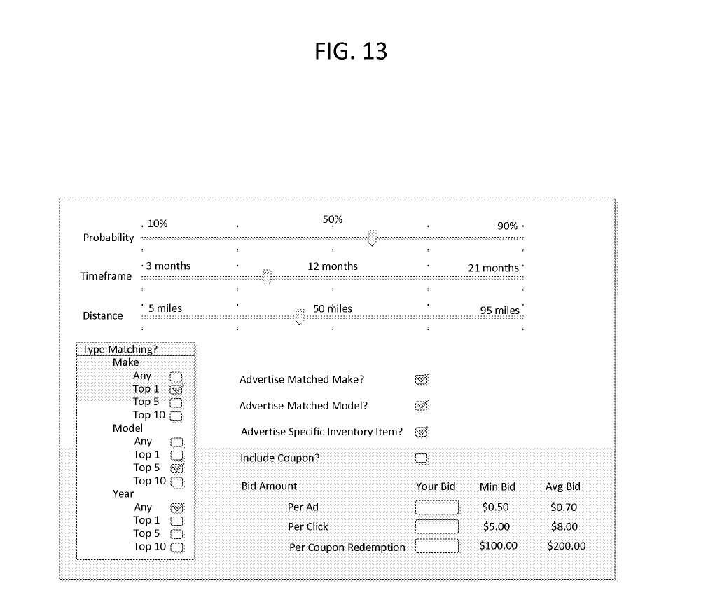

In decision block 1020 it is determined whether the thresholds established by the vendor under consideration are met by the predictions. Thresholds may be specified by the vendors when submitting a bid, such as the one shown in FIG. 13. If the vendor did not specify a threshold for one or more of the predictions, then default threshold vales may be used.

For example, the vendors may select a probability threshold, a timeframe threshold, and a distance threshold as indicated by the sliders in FIG. 13 (although any means of selecting the thresholds may be used). The probability threshold is met if the predicted probability meets/exceeds the threshold. The timeframe threshold is met if the predicted time frame is within the threshold time frame. The distance threshold is met if a distance from the vendor to the vehicle location is less than the threshold.

With regard to the predicted type of transaction, the threshold is not necessarily numerical, and may simply include a selection of “types” by the vendor—if the predicted type for the transaction meets one or more of the selected types, then the threshold for type is met. For example, in the bid shown in FIG. 13, the dealers may select from “any”, “top 1”, “top 5”, or “top 10” in the types of “make”, “model”, and “year”. Thus, if the selections shown in FIG. 13 are assumed as an example, then the type thresholds would be met if the dealer sells a vehicle that is either (1) the top 1 make predicted for the target user or (2) one of the top 5 models predicted for the target user. A default threshold for type may be set to “any”, meaning that the default threshold will always be met.

If the vendor's thresholds are met or exceeded (result=YES), then the process proceeds to process block 1030. If the vendor's thresholds are not met (result=NO), then the process proceeds to process block 1040.

If process block 1030 is reached, the vendor under consideration is flagged as a potential advertiser. If process block 1040 is reached, the vendor under consideration is discarded from future consideration for the target user. The process then proceeds to decision block 1050.

In decision block 1050, it is determined whether there are any vendors remaining that have not yet been considered. If so (result=YES), the process loops back to block 1010 and repeats, if not (result=NO), then the process continues on to process clock 1060.

In process block 1060 one of those vendors that was flagged as a potential advertiser is selected. The selection may be based, for example, upon bids of the vendors, a history of prior advertisements, or any other consideration. For example, the flagged vendor with a highest bid amount (discussed further below) may be selected. Alternatively, selection of vendors may be made so as to more evenly distribute the number of advertisements delivered for each vendor; for example, suppose three advertisers have been flagged, two have had twenty advertisements delivered in the past week and one has had only ten advertisements delivered in the last week—the vendor with ten ads may be selected. Alternatively, a history of advertisements to that particular user may be consulted; for example it may be desirable to prevent the same advertisement from being delivered to the user too often, or, contrary wise it may be desirable to ensure that the same advertisement is delivered repeatedly.

In process block 1070 the advertisement is generated for the selected vendor. The advertisement may be further directed to the predicted type of the transaction. For example, if the transaction is replacement of the vehicle, the advertisement may be for the (or one of the) specific category(ies), make(s), model(s), and/or year(s) of vehicle that is predicted for the type of replacement vehicle.

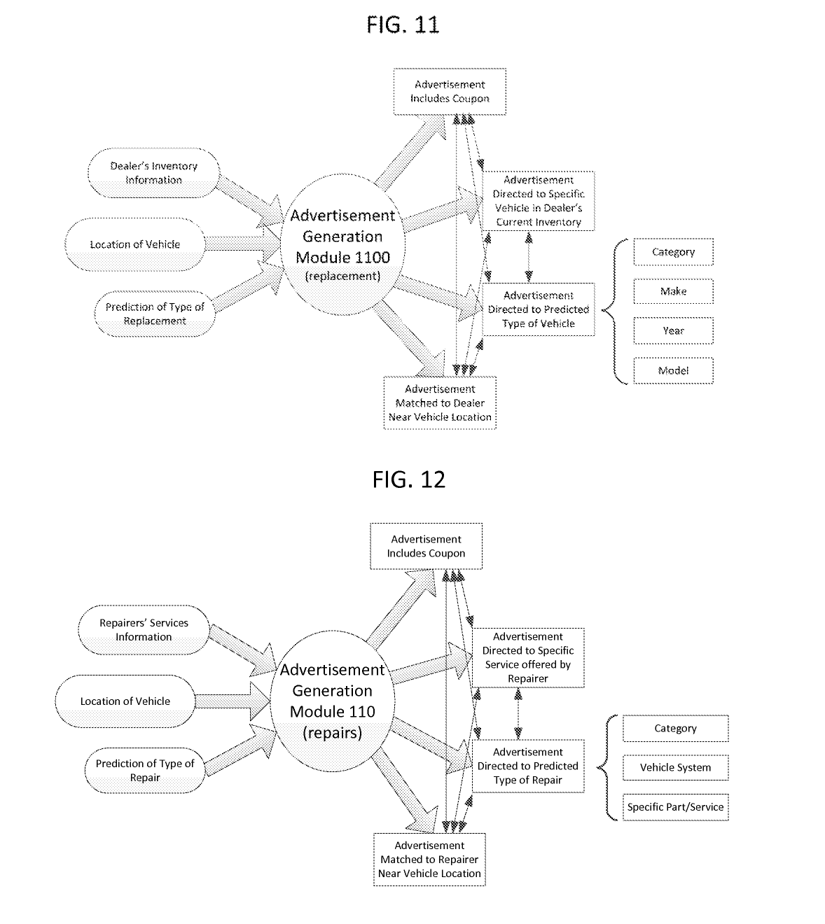

FIG. 11 illustrates a conceptual view of how the advertisement generation module 1100 may generate the advertisements when the vehicle related transaction is the replacement of the target user's vehicle. The advertisement generation module 1100 may receive as inputs the predictions about the type of replacement vehicle, the location of the vehicle, and inventory information from various dealers. The module 1100 may then generate various types of targeted advertisements based on some or all of this input information.

For example, the module 1100 may generate an advertisement for a dealer that is located near the target user's vehicle location (within a predetermined threshold distance). The threshold distance may be a default distance or may be set by the dealer. For example, when dealers submit an advertisement bid to the module 1100, such as the one shown in FIG. 13, they may select a location threshold, for example via the illustrated distance slider or any other means. A dealer's advertisements will only be delivered to a user whose distance from the dealer is less than their location threshold (see process block 1020 of FIG. 10). The dealer can thereby have greater control over to whom their advertisements are delivered. A price charged for the advertisement may increase as the distance threshold is decreased, since decreasing the threshold creates a more targeted (and hence more valuable) advertisement.

The module 1100 may also generate an advertisement directed to the specific type of vehicle that corresponds to (one of) the predicted type(s) of the replacement vehicle. As discussed above, the predicted type of a vehicle may include a category of the vehicle (e.g., minivan, luxury car, etc.), may include the make of the vehicle (Ford™, BMW™, etc.), may include the model of the vehicle (e.g., Fusion™, M5™, etc.), and may include the year of the vehicle. The type of vehicle that is included in the advertisement may be one, in an example, sold by the selected dealer for whom the advertisement is being made. A dealer may specify in their bid whether they want to require that their advertisement only be directed to a person for whom the predicted type matches one of the types sold by the dealer. For example, in the exemplary bid shown in FIG. 13, the dealer can select matching requirements for the type of vehicle, and their advertisement will only be delivered to a user whose predicted type meets the selected types. For example, in the exemplary bid of FIG. 13 the dealer has selected “top 1” for Make, “top 5” for Model, and “any” for Year. Thus, an advertisement for the dealer will only be sent to the target user if the target user's top predicted make is sold by the dealer, or if at least one of the target user's top five models is sold by the dealer. The dealer may also select whether or not they want the advertisement to be specifically directed to a make or model sold by the dealer that matches the criteria for the predicted type. A price charged for the advertisement may increase as the number and/or strictness of type-matching criteria is increased, since increasing the number and/or strictness of the type-matching criteria creates a more targeted (and hence more valuable) advertisement.

The module 1100 may also generate an advertisement that is directed to a specific vehicle in the dealer's current inventory. The specific vehicle advertised may, in one exemplary approach, be one of a type that matches one of the predicted types of replacement vehicles. The dealer may select whether or not they want the advertisement to be directed to a specific vehicle in their inventory, as opposed to being merely a general advertisement for the dealer or for a type of vehicle sold by the dealer. A price charged for the advertisement may increase if the advertisement is for a specific vehicle, since such an advertisement is much more targeted (and hence more valuable). In addition, the advertisement may include some of the information related to the target user's vehicle upon which the prediction of replacement was based. For example, if the vehicle data indicates that the target user's vehicle is ten years old, the targeted advertisement may include a statement such as “your car is over ten years old, time to get a new one . . . . ” along with an advertisement for a specific new car.

The module 1100 may also generate an advertisement that includes a coupon that the targeted user may redeem at the selected dealer. The coupon may, in one illustration, be time sensitive, which is thought to provide greater motivation to act upon the coupon. Such a coupon is much more likely to increase the motivation of the target user to purchase a vehicle than an advertisement alone might be, and thus an advertisement including such a coupon may command a higher price. Moreover, if the coupon is redeemed a much higher price may be exacted, since the redemption has proven the effectiveness of the advertisement.

As indicated conceptually by the double-sided arrows connecting various of the boxes in FIG. 11, each of the aforementioned types of advertisements may be combined with one another. For example, a coupon may be combined with an advertisement for a specific vehicle in a dealers inventory for a dealer located near the target user. The details of the advertisement may be specified by the dealer, or if not specified may be left to a default selection.

FIG. 12 illustrates conceptually how the module 1100 may generate advertisements when the vehicle related transaction is the repair of a vehicle. The advertisement generation module 1100 may receive as inputs the predictions about the type of repair, the location of the vehicle, and inventory information from various repair service providers. The module 1100 may then generate various types of targeted advertisements based on some or all of this input information. The types of advertisements are similar to those discussed with respect to FIG. 11, and thus to avoid redundancy only certain aspects of FIG. 12 will be discussed.

The module 1100 may generate an advertisement for a specific type of repair offered by the selected repairer that matches a predicted type of repair for the target user, the types including categories of repair, systems of the vehicle to be repaired (e.g., drive train, cooling, etc.), and specific parts to be repaired. The module 1100 may also generate an advertisement for a specific repair service that is offered by the repairer, such as an oil change, tune up, or transmission rebuild. In addition, the advertisement may include some of the information related to the target user's vehicle upon which the prediction was based. For example, if the vehicle data includes diagnostic codes that would indicate that the vehicle's “check engine” light is on, and a predicted type of repair is an engine tune up, the targeted advertisement may include a statement such as “your check engine light is on . . . ” along with an advertisement for an engine tune up.

FIG. 13 illustrates an exemplary bid interface that a vendor can use to submit an advertisement bid. Certain details of the exemplary bid interface have already been discussed above, and thus will not be repeated here. Although the bid interface shown in FIG. 13 is directed toward transactions involving replacement of a vehicle, a similar bid interface could be provided for transactions involving repair of a vehicle. The bid interface is, for example, a web interface that allows vendors to communicate vendor information to the aggregation sever 115 (or whatever computing device is running the module 1100).

The bid interface allows a vendor to customize their advertisement purchases. The vendor can select how targeted their advertisements will be. More highly targeted advertisements are in general more effective, and hence are worth more to the vendor. Thus, the more targeted the advertisement the higher the price charged for the ad may be. On the other hand, the highly targeted ads will be delivered to fewer users on average than less targeted ads. This is because the highly targeted ads will have stricter matching criteria, and thus fewer users will match the criteria. Thus, as an add becomes more highly targeted at some point the effectiveness will cease to increase with increasing levels of targeting, and may even begin to diminish in effectiveness with increasing levels of targeting. The optimal level of targeting may be difficult to find, and may vary from business to business according to their business model, risk tolerance, marketing philosophy, and so on. Thus, the bid interface is extremely advantageous in that it allows each vendor to select their own balance between targeting and mass distribution of their advertisements, as well as selecting a price-point that they are comfortable with.

The bid interface may calculate a price for each advertisement based on the selections made by the vendor. The price may simply be a fixed price for the selected level of targeting, or may be variably set according to how many bids at that level of targeting have been received. It is also possible that the bid interface may calculate a minimum bid price for the level of targeting selected, but also allow the vendor to specify a higher bid price. The minimum bid shows the vendor the least they can bid for the level of targeting they have selected, but the vendor may wish to bid a price higher than this in order to ensure that their advertisements are selected for delivery to the target user in the event that multiple vendor's matching criteria are met by the target user (assuming that the selection is based upon highest bid price).

For example, suppose that three vendors are flagged as potential advertisers in step 1030 of the process shown in FIG. 10, and their respective bid prices are $0.50, $0.75, and $1.25—in such a case the vendor who bid $1.25 may be selected in step 1060 of the process shown in FIG. 10. Of course, the selection process may be more complicated than that, including of other factors besides bid price. For example, the selection may have override rules that ensure that repeat selections do or do not occur, and so on. As another example, the selection may be configured so as to ensure that every vendor's ad has at least some chance of being selected, but with the chance being proportional to their bid amount. For example, the vendor may be selected by assigning each vendor a range of numbers (x,y], all of the ranges together filling in the range (0,1], with the width of the range (x,y] being proportional to the bid amount of the respective vendor. Then a random number in the range (0,1] can be generated, and the vendor whose range (x,y] encompasses the random number is the selected vendor. Thus, taking the three vendors mentioned above as an example, the first vendor may be assigned the range (0,0.2], the second vendor may be assigned the range (0.2, 0.5], and the third vendor may be assigned the range (0.5,1]. The first vendor has a 20% chance of being selected, the second a 30% chance, and the third a 50% chance.

As shown in FIG. 13, an average bid amount may also be shown to help the vendor gauge the appropriate amount for their bid.

FIG. 13 shows different bid amounts for “per ad”, “per click”, and “per coupon redemption”. The per ad amount is the amount charged for every ad that is delivered. The per click amount is in addition to the per ad amount, and is charged for every time a user selects one of the delivered ads. The per coupon redemption amount is only used when a coupon is included in the ad, and is only paid when the coupon is redeemed. Generally, the amount paid per ad is less than the amount paid per click, which is less than the amount paid for a coupon redemption. Moreover, additional bidding options may be included, and/or some of these bidding options may be excluded. In addition, the different prices may stack on each other as described above (if an add is clicked the vendor pays for both the per ad price and the per click price), or they may not stack (e.g., if an ad is clicked the vendor pays the per click price but not the per ad price).

Although not illustrated, if the vendor selects to include a coupon in the advertisement, an interface for obtaining information related to the coupon may be provided. The vendor may specify, for example, the incentive provided by the coupon (e.g., $1000 off, free oil change for life, etc.), as well as any terms and conditions.

The vendor may also submit one or more advertisements along with the bid. If the vendor is selected for the target user, then one of the vendor's advertisements is selected for delivery to the target user according to the criteria discussed above. In one example, the vendor submits ads corresponding to the matching selections made by the vendor in the bid interface. For example, if the vendor selected any of the type matching criteria (other than the default “any” selection), it may be desired that the vendor submit ads for each of the types of vehicles the vendor sells, so that if the predicted type of replacement vehicle matches a type in the vendor's inventory an advertisement corresponding to that predicted type of vehicle can be delivered to the target user. Thus, for example, if the vendor selected “Top 5” in “models”, it may be preferable in an example that the vendor provide an ad for each of the models of vehicles in the vendors inventory. Thus, if any of the models the vendor sells match one of the top five predicted models for the target user, an ad for that matching model can be delivered. The vendor can even submit ads for some or all of the specific vehicles for sale in their inventory, which can be matched to the target user's predicted vehicle type. If the vendor does not specify any matching criteria, a general advertisement for that particular vendor may be delivered, or even an advertisement for a specific type of vehicle regardless of whether it matches the predicted type for the user. The vendor may also select whether or not they desire the advertisement to be directed to the matched make or model. Thus, it is possible that an advertiser may select a matching criteria such as “top 5” in “make”, but desire to only have a general advertisement for their dealership delivered rather than a “make” specific advertisement. This may be the case because some dealerships sell multiple makes of vehicles, and the dealer may not want to single out only one (or perhaps the make sold by the dealer is implicit in the name of the dealership, and thus a general advertisement for the dealership may suffice).

As an alternative to receiving advertisements from the vendors, the module 1100 may create the advertisements based on the vendor information. For example, a set of advertisement templates may be used, and the targeted advertisement may be created by taking one of the templates and inserting images and text corresponding to the desired subject matter of the advertisement. An image database containing images corresponding to various dealer, makes, models (of various years) and such may be maintained for this purpose. For example if the advertisement is supposed to be for the dealer “Bob's Auto” and is supposed to advertise a “Ford Focus™”, then the image database could be searched for a logo/trademark corresponding to Bob's Auto and for an image of a Ford Focus™, and these images could be added in to one of the ad templates along with text related to Bob's Auto and the Ford Focus™. In particular, if vender information submitted by Bob's Auto included a price for a Ford Focus™, then such a price could also be inserted into the template. The vendor may be able to select the template that they would like their advertisement constructed from when submitting the bid information, as well as the various images and other information (e.g., prices, inventory). An advantage of this approach is that the dealers do not have to create and submit multiple advertisements (e.g., one for each model they sell). Further, when prices change the dealers do not have to submit new advertisements, but instead can simply update the price information with the module 1100.

It will be understood that the vendors' selections can be obtained through many other means besides those shown in FIG. 13, for example via a web interface configured differently than the one shown in FIG. 13, via a telephone order, via a paper order, via email, etc. Moreover, it will be understood that the options provided to a vendor for selection may differ from those shown in FIG. 13, for example allowing for more or less specificity in the categories provided, providing more or less categories, and so on.

The prediction heuristic 400 and the advertisement module 1100 are provided as software in an exemplary approach, which when executed by one or more CPUs provide the operations described herein. Alternatively the prediction heuristic 400 and the advertisement module 1100 may be provided as hardware or firmware, or combinations of software, hardware and/or firmware. Additionally, although one example of the modularization of each of the prediction heuristic 400 and the advertisement module 1100 are illustrated and described, it should be understood that the operations thereof may be provided by fewer, greater, or differently named modules.

In general, computing systems and/or devices, such as the aggregation server 115, processor 210, and the CPU(s) running the prediction heuristic 400 and/or the advertisement module 1100 may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Fusion™, Focus™, and Ford™ are trademarks of Ford Motor Company. 4Runner™, Tacoma™, and Toyota™ are trademarks of Toyota Motor Corporation. M5™ and BMW™ are trademarks of BMW of North America, LLC, a subsidiary of Bayerische Motoren Werke AG. Model S™ and Tesla™ are trademarks of Tesla Motors, Inc.

1. A method comprising causing a processor to:
receive vehicle information from on-board devices installed in a plurality of vehicles; and
predict, based on the vehicle information, that a given user of a given vehicle of the plurality of vehicles will engage in a financial transaction involving their vehicle within a predetermined amount of time.

2. The method of claim 1,
wherein the prediction that the given user will engage in the financial transaction is further based on demographic information about the users of the plurality of vehicles.

3. The method of claim 1,
wherein the financial transaction includes replacing the given vehicle with a replacement vehicle, and the method further comprises:
causing the processor to predict, based on the vehicle information, a type of the replacement vehicle.

4. The method of claim 3,
wherein the prediction of the type of the replacement vehicle is further based on demographic information about the users of the plurality of vehicles.

5. The method of claim 3,
wherein predicting the type of the replacement vehicle includes predicting a make of the replacement vehicle.

6. The method of claim 3,
wherein predicting the type of the replacement vehicle includes predicting a model of the replacement vehicle.

7. The method of claim 1,
wherein the financial transaction includes purchasing repairs for the given vehicle, and the method further comprises:
causing the processor to predict, based on the vehicle information, a type of the repair.

8. The method of claim 1, further comprising:
causing the processor to determine a probability, based on the vehicle information, that the given user will engage in the financial transaction involving their vehicle within the predetermined time period,
wherein the processor predicts that the given user will engage in the financial transaction when the determined probability exceeds a predetermined probability threshold.

9. The method of claim 1, further comprising:
causing the processor to predict, based on the vehicle information, a timing when the given user will engage in the financial transaction involving their vehicle,
wherein the processor predicts that the given user will engage in the financial transaction when the predicted timing is within the predetermined time period.

10. The method of claim 1, further comprising:
delivering to the given user an advertisement whose subject matter corresponds to the financial transaction.

11. A method comprising,
causing a processor to:
receive vendor information,
obtain a prediction that a given user of a given vehicle of a plurality of vehicles will engage in a financial transaction involving their vehicle within a predetermined time period, the prediction having been generated based on vehicle information from on-board devices installed in the plurality of vehicles, and
match a vendor to the given user based on the prediction and the vendor information; and
deliver to the given user an advertisement from the matched vendor, the subject matter of the advertisement corresponding to the financial transaction.

12. The method of claim 11,
wherein the advertisement's subject matter includes merchandise indicated by the vendor information as being currently available in the matched vendor's inventory.

13. The method of claim 11,
wherein the advertisement includes a coupon or promotional offering a discount for a specific item of merchandise that is indicated by the vendor information as being currently available in the matched vendor's inventory.

14. The method of claim 13,
wherein an amount of a fee paid by the vendor for the advertisement depends upon whether or not the coupon is redeemed.

15. The method of claim 12,
wherein the financial transaction involves replacement of the respective vehicle with a replacement vehicle.

16. The method of claim 15, further comprising:
causing the processor to determine a location associated with the given vehicle,
wherein the matching of the vendor to the given user is further based on whether the vendor is located within a predetermined distance from the determined location associated with the given vehicle.

17. The method of claim 15, further comprising:
causing the processor to obtain a second prediction specifying a type of the replacement vehicle, the second prediction having been generated based on the vehicle information, and
tailoring the subject matter of the advertisement to the predicted type of the replacement vehicle.

18. The method of claim 17,
wherein the advertisement includes a coupon or promotional offering a discount for a specific vehicle that is indicated in the vendor information as being currently in the matched vendor's inventory and that is of the predicted type of the replacement vehicle.

19. The method of claim 15,
causing the processor to obtain a second prediction specifying at least one predicted make or model of the replacement vehicle, the second prediction having been generated based on the vehicle information, and
the advertisement is directed toward the at least one predicted make or model.

20. The method of claim 11,
wherein the financial transaction involves a repair of the respective vehicle.

21. The method of claim 20, further comprising:
causing the processor to determine a location associated with the given vehicle,
wherein the matching of the vendor to the given user is further based on whether the vendor is located within a predetermined distance from the determined location associated with the given vehicle.

22. The method of claim 20, further comprising:
causing the processor to obtain a second prediction specifying a type of the repair, the second prediction having been generated based on the vehicle information, and
tailoring the subject matter of the advertisement to the predicted type of the repair.

23. A method comprising:
causing a processor to:
receive a plurality of advertisement bids each having a corresponding target probability and a corresponding time period,
receive vehicle information from on-board devices installed in a plurality of vehicles,
predict, based on the vehicle information, for each of the corresponding time periods, a probability that a given user of a given vehicle of the plurality of vehicles will engage in a financial transaction involving their vehicle within the respective time period, and
match one of the plurality of advertisement bids to the given user based on whether the predicted probability for the respective advertisement bids corresponding time period exceeds the respective advertisement bid's corresponding target probability; and
delivering to the given user an advertisement corresponding to the one of the plurality of advertisement bids matched to the given user.

24. A method comprising:
causing a processor to:
receive a plurality of advertisement bids each having a corresponding target time period,
receive vehicle information from on-board devices installed in a plurality of vehicles,
predict, based on the vehicle information, for each of the advertisement bids, whether a given user of a given vehicle of the plurality of vehicles will engage in a financial transaction involving their vehicle within the respective advertisement bid's corresponding target time period, and
match one of the plurality of advertisement bids to the given user based on the prediction; and
delivering to the given user an advertisement corresponding to the one of the plurality of advertisement bids matched to the given user.
